(19) United States
(12) Patent Application Publication
(10) Pub. No.: US 2020/0149637 A1
(43) Pub. Date: May 14, 2020

(54) UNION

(71) Applicant: Seong Gyun MOK, Gimpo-Si, Gyeonggi-Do (KR)

(72) Inventor: Seong Gyun MOK, Gimpo-Si, Gyeonggi-Do (KR)

(21) Appl. No.: 15/558,231

(22) PCT Filed: Aug. 17, 2017
(86) PCT No.: PCT/KR2017/008931

§ 371 Date: Sep. 14, 2017

(30) Foreign Application Priority Data
Aug. 4, 2017 (KR) 10-2017-0099123

(51) Int. Cl. F16J 15/3272; F16L 19/02; F16L 17/06; F16L 15/04; F16L 33/24; F16L 25/00

(52) U.S. Cl. CPC F16J 15/3272; F16L 19/0212; F16L 25/0036; F16L 15/04; F16L 33/24; F16L 17/06

(57) ABSTRACT

Disclosed is a union which is capable of self-sealing without a need for additional piping materials and sealing means, as well as being capable of forming a pipe conduit through a simple installation. The union includes a main pipe which has one end that is connected to an adapter installed to introduce or discharge a fluid into equipment to form a pipe conduit; a joint which is able to be idle and provided at one end of the main pipe, and has a screw thread corresponding to a screw thread formed at an end of the adapter to connect one end of the main pipe to the end of the adapter through the screw thread; and a stopper which is inserted and fixed in a stopper groove formed at one end of the main pipe to prevent the joint from being detached from the main pipe.

### TECHNICAL FIELD

The present invention relates to a union, and more particularly, to a union which is capable of self-sealing without a need for additional piping materials and sealing means, as well as being capable of forming a pipe conduit through a simple installation.

### BACKGROUND ART

In the case of various equipment requiring a fluid access such as boiler, pump, engine, etc., it is essential to form a pipe conduit for supplying and discharging fluid such as water, gas, oil, or the like used in the equipment.

A pipe fitting refers to a component of piping used to connect between pipes when forming the pipe conduit, for example, a union, an elbow, a tee, a nipple, a plug, or the like.

Among these, the union is a pipe joint material that connects a portion where two pipes meet by using a nut having screw threads.

In the case of a conventional union, as shown in FIG. 1, pipes are connected by using a union nut 10 having a female screw formed therein.

At this time, the union nut 10 is divided into two portions including a portion connected to an adapter 20 and a portion connected to a pipe 30. Since each portion is specially manufactured to idle independently, a defect rate and a manufacturing cost are relatively high.

In the case of a pipe connection work using the union nut 10, a pipe is connected primarily to the adapter 20 which has a male screw, and then it is necessary to perform a secondary work for connecting to another pipe 30 by tightening the union nut 10. Therefore, the work itself is rather cumbersome.

In particular, since most equipment including a boiler or the like are disposed in a narrow space due to the nature of the equipment, it is difficult to secure a working space required for a work to tighten the union nut by using a spanner or the like. Hence, the above problem becomes more evident.

Furthermore, in the case of the pipe 30 used for a boiler or the like, the volume and the weight are considerable due to a valve device or the like integrally provided in the pipe 30 itself, and thus, more man-hour is required for a work in the narrow space.

In addition, in the case of the conventional union, since a work of winding a teflon tape 40 to a connection region several times must be accomplished so as to achieve a sealing before joining the union nut 10 to the adapter 20, the time and the man-hour consumed in the pipe connection work should be increased.

In addition, since the sealing method using a teflon tape requires a reworking when the pipe is separated for the maintenance or the replacement of piping, there exists another problem that additional cost, time, and man-hour due to management are consumed.

Therefore, it is required to develop a new type of pipe joint which can solve the problem of the above described conventional union.

### DISCLOSURE

### Technical Problem

The present invention has been made in view of the above problems, and provides a union which is capable of self-sealing without a need for additional piping materials and sealing means, as well as being capable of forming a pipe conduit through a simple installation.

Meanwhile, the present invention is not limited to the above-described technical problems, and other technical problems not mentioned may be clearly understood by those skilled in the art from the description below.

### Technical Solution

In an aspect, there is provided a union including: a main pipe which has one end that is connected to an adapter installed to introduce or discharge a fluid into equipment to form a pipe conduit; a joint which is able to be idle and provided at one end of the main pipe, and has a screw thread corresponding to a screw thread formed at an end of the adapter to connect one end of the main pipe to the end of the adapter through the screw thread; and a stopper which is inserted and fixed in a stopper groove formed at one end of the main pipe to prevent the joint from being detached from the main pipe.

The stopper is formed of a ring having an outer diameter larger than an outer diameter of the main pipe, and wherein the joint is inserted into the main pipe through one end of the main pipe, is able to move along a longitudinal direction of the main pipe and to be idle on the main pipe, and has an engagement protrusion, formed at a lower end, having an inner diameter smaller than the outer diameter, wherein a movement of the joint on the main pipe is restricted in any one direction to prevent the joint from being detached from one end of the main pipe.

the stopper is disposed between an outer circumferential surface of the main pipe and an inner circumferential surface of the joint where the engagement protrusion is formed to prevent the fluid which is introduced or discharged through the adapter from leaking to an external, when the end of the adapter and one end of the main pipe are connected by the joint.

The stopper includes an opening portion in which a part of continuous ring shape is broken open, and is shrunk by elastic deformation while being fitted to the outer circumferential surface of the main pipe through the opening portion and fixed to the stopper groove.

The stopper includes a stretcher which is formed on an opposite side of the opening portion and has a section where a cross-sectional area is sharply reduced.

The stopper includes a stopper packing provided around a ring-shaped outer circumferential surface, wherein the stopper packing is provided to be in close contact with an inner circumferential surface of the joint where the engagement protrusion is formed, when the end of the adapter and one end of the main pipe are connected by the joint.

The union further includes a gasket which is disposed between the end of the adapter and one end of the main pipe, when the end of the adapter and one end of the main pipe are connected by the joint.

The gasket is made of an elastomer including rubber, silicone, and the like, and is compressed by one end of the main pipe and the end of the adapter approaching each other through a relative movement of screw threads as the joint rotates.

A gasket hole is formed in a center of the gasket so as to allow the fluid to pass through, wherein the adapter is provided with a sealing guide provided to abut against and be inserted into an inner circumferential surface of the gasket hole, when the end of the adapter and one end of the main pipe are connected by the joint.

### Advantageous Effects

The union according to the present invention having the above-described configuration has an effect that it is possible to implement a self-sealing without a need for additional piping materials and sealing means, as well as to form a pipe conduit through a simple installation.

Meanwhile, the effects of the present invention are not limited to the effects mentioned above, and other effects not mentioned can be clearly understood by those skilled in the art from the description of the claims.

### DESCRIPTION OF DRAWINGS

FIG. 1 shows a pipe joint using a conventional union.

FIG. 2 to FIG. 5 show a configuration of a union according to the present invention.

FIG. 6 shows an example in which a union according to the present invention is applied to a corrugated pipe.

FIG. 7 to FIG. 9 show examples of a stopper that can be variously configured according to the present invention.

FIG. 10 shows a gasket of a union according to the present invention.

FIG. 11 shows a sealing guide that can be added to an adapter according to an embodiment of the present invention.

FIG. 12 to FIG. 13 show an example of a gasket formed corresponding to the sealing guide.

FIG. 14 shows a sealing using the gasket and the sealing guide according to the present invention.

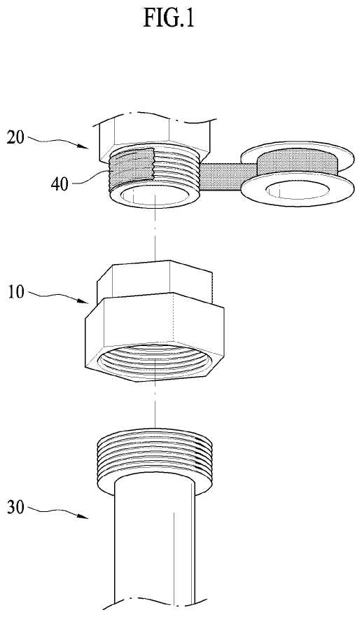

### EXPLANATION OF REFERENCE NUMERAL

20: Adapter
100: Main pipe
200: Joint
300: Stopper
400: Corrugated pipe
500: Gasket
600: Sealing guide

### MODE FOR INVENTION

Hereinafter, preferred embodiments of the present invention will be described with reference to the accompanying drawings. In describing the present embodiment, the same designations and the same reference numerals are used for the same components, and further description thereof will be omitted.

Further, in describing the present embodiment, the configuration shown in the drawings is only an example for helping understanding of the detailed description, and thus the scope of the present invention is not limited.

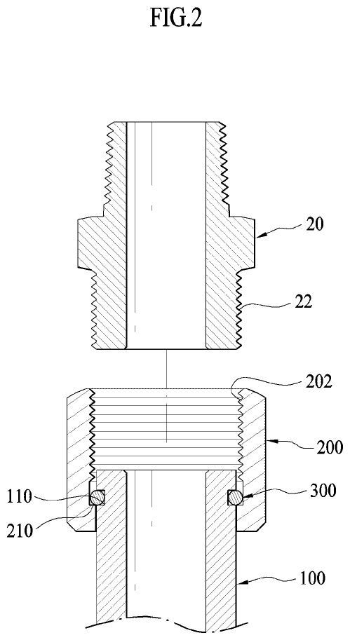

First, the configuration of the union according to the present embodiment will be described with reference to FIG. 2 to FIG. 5.

As shown in FIG. 2, the union according to the present embodiment may include a main pipe 100, a joint 200, and a stopper 300.

The main pipe 100 may be connected to an adapter 20 to extend the flow of a fluid including water, gas, fuel and the like. The main pipe 100 may have one end connected to an end of the adapter 20 to form a pipe conduit.

Here, the adapter 20 may be installed in the equipment so as to introduce or discharge the fluid and may be connected to the main pipe 100. The end of the adapter 20 may be provided with a male screw having screw threads formed along an outer circumferential surface and may be screwed to the joint 200 described later.

The joint 200 may be configured to connect the main pipe 100 and the adapter 20, and screw threads of a female screw corresponding to screw threads of the male screw formed at the end of the adapter 20 may be formed along an inner circumferential surface.

Such a joint 200 may be provided at one end of the main pipe 100 and able to be idle, and may connect one end of the main pipe 100 to an end of the adapter 20 by fitting the female screw to the male screw of the adapter 20 in a state where the main pipe 100 is adjacent to the end of the adapter 20.

At this time, the joint 200 may be idle on one end of the main pipe 100 and may be screwed to the end of the adapter 20, and the main pipe 100 may not rotate regardless of the rotation of the joint 200.

The stopper 300 may be configured to prevent the above described joint 200 from being detached from the main pipe 100, and may be inserted and fixed into a stopper groove 110 formed at one end of the main pipe 100.

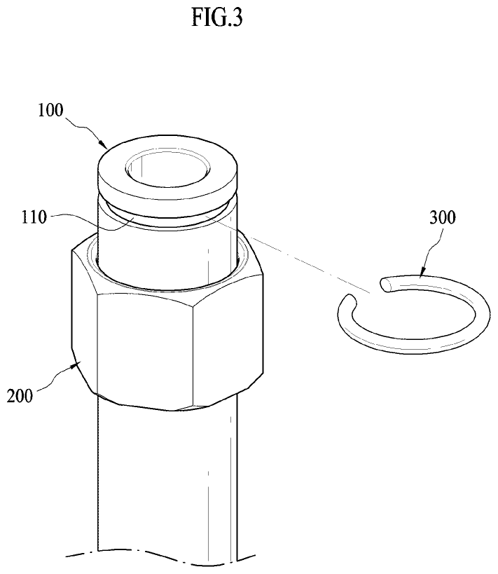

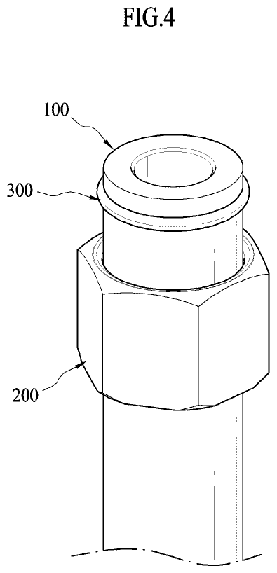

As shown in FIGS. 3 to 4, the stopper 300 may be formed of a ring having an outer diameter larger than the outer diameter of the main pipe 100, and may be inserted into the stopper groove 110 exposed to the outside in a state where the joint 200 is inserted first on the main pipe 100.

At this time, the joint 200 may be inserted into the main pipe 100 through one end of the main pipe 100, may move along the longitudinal direction of the main pipe 100 and be able to be idle on the main pipe 100. Therefore, the joint 200 may move along the longitudinal direction of the main pipe 100 while being inserted to the main pipe 100 before the main pipe 100 is coupled so that the stopper groove 110 may be exposed to the outside.

In addition, an engagement protrusion 210 (see FIG. 2) having an inner diameter smaller than the outer diameter of the stopper 300 may be formed at the lower end of the joint 200, so that the movement of the joint 200 on the main pipe 100 may be restricted in any one direction.

That is, the joint 200 may be prevented from being detached from one end of the main pipe 100 by the stopper 300 inserted and fixed in the stopper groove 110 having an outer diameter larger than the outer diameter of the main pipe 100 and the inner diameter of the engagement protrusion 210.

The union according to the present embodiment having the above-described configuration may screw the joint 200, which is provided to be able to be idle on the main pipe 100 by the stopper 300, to the adapter 20. Therefore, it is possible to easily perform the pipe connection work for a connecting pipe such as the adapter 20 requiring a pipe connection.

As described above, since the adapter 20 and the main pipe 100 can be connected to each other through only a single screw connection of the joint 200, the present invention does not require an inconvenience mentioned in the background art that the union nut should be connected to the two pipes respectively.

Particularly, when the union of the present invention is applied to equipment such as a boiler, it is possible to achieve a pipe connection by only a single connection work compared to the conventional union, so that it is possible to reduce the man-hour of work in a narrow space, and easily accomplish maintenance such as cleaning, repair, and replacement.

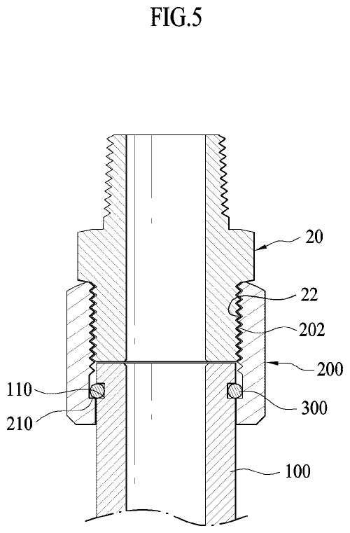

Further, as shown in FIG. 5, in the case of the stopper 300 according to the present embodiment, when the end of the adapter 20 and one end of the main pipe 100 are connected by the joint 200, the stopper 300 may be disposed between the outer circumferential surface of the main pipe 100 and the inner circumferential surface of the joint 200 where the engagement protrusion 210 is formed.

Thus, the stopper 300 may be naturally brought into close contact with a gap formed between the inner circumferential surface of the engagement protrusion 210 and the outer circumferential surface of the main pipe 100 so that the fluid flowing between the adapter 20 and the main pipe 100 can be prevented from leaking to the outside. Accordingly, a separate sealing is not required.

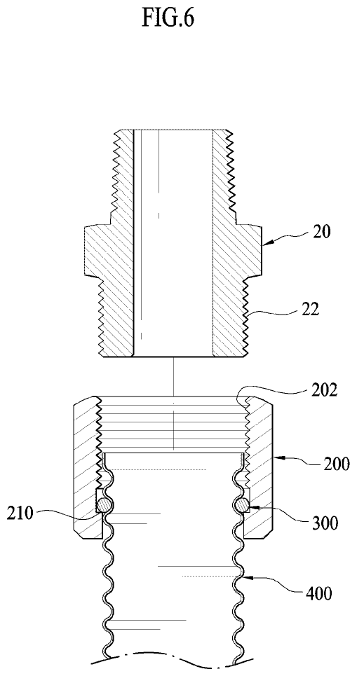

Further, as shown in FIG. 6, since the stopper 300 of the present embodiment is applicable even if the main pipe is formed of a corrugated pipe 400, the union of the present invention can be unconstrainedly replaced with and mounted in the existing equipment to which the corrugated pipe 400 is applied.

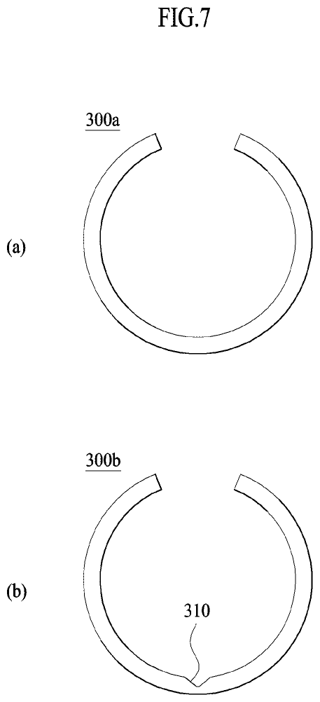

Next, examples of the stopper 300, which can be variously configured according to the present invention, will be described with reference to FIG. 7 to FIG. 9.

As described above, the stopper 300 according to the present invention is configured to be inserted into the stopper groove 110 formed in the main pipe 100 to prevent the joint 200 from being detached. In order to perform this, it can be configured as follows.

As shown in FIG. 7(a), a basic stopper 300a may be made of a material having elasticity including a metal material and may be formed in a continuous ring shape while including an opening portion in which a part of the continuous ring is broken and opened.

The stopper 300a may be shrunk by elastic deformation while being fitted to the outer circumferential surface of the main pipe 100 through the opening portion, and fixed to the stopper groove 110.

In addition, as shown in FIG. 7(b), the stopper 300b may further include a stretcher 310 which is formed on the opposite side of the opening portion and has a section where the cross-sectional area is sharply reduced.

Such a stretcher 310 may be formed on the opposite side of the opening portion which is a section where the stopper 300b receives the greatest force so as to be inserted into the stopper groove 100, thereby reducing the elastic deformation applying on a corresponding portion so that the stopper 300b can be more easily opened.

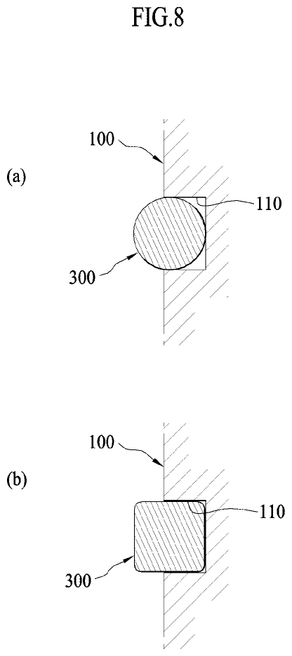

In addition, as shown in FIGS. 8(a) and 8(b), the vertical section of the stopper 300 according to the present invention may be formed in a circular or rectangular shape.

In case the vertical section of the stopper 300 is formed in a circular shape, the range of the flow may be more flexible when the stopper 300 enter the stopper groove 110 or when the joint 200 engages the adapter 20. In case the vertical section of the stopper 300 is formed in a rectangular shape, occurrence of clearances can be reduced and air tightness can be improved.

However, the above described vertical cross-sectional shape of the stopper 300 is merely an example of the embodiments of the present invention, and does not mean that the vertical cross-sectional shape of the stopper 300 is not limited. Thus, it is obvious that the detailed shape of the stopper 300 of the present invention is a part that can be changed freely as required by design.

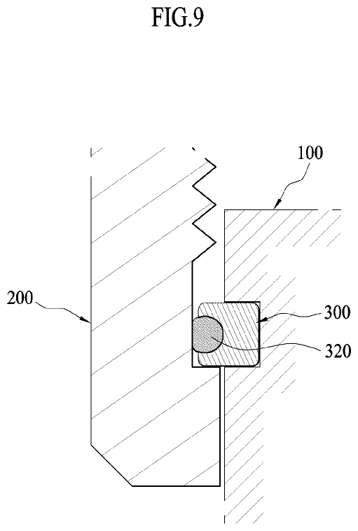

Meanwhile, as shown in FIG. 9, the stopper 300 of the present invention may include a stopper packing 320 provided around a ring-shaped outer circumferential surface.

Here, the stopper packing 320 may be provided to be in close contact with the inner circumferential surface of the joint 200 where the engagement protrusion 210 is formed when the end of the adapter 20 and one end of the main pipe 100 are connected by the joint 200 so that the air tightness through the stopper 300 can be more improved.

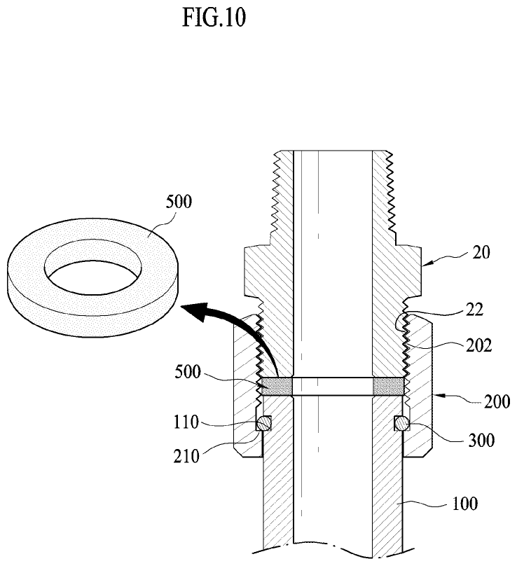

Next, a further configuration that can be additionally formed in the union of the present invention will be described with reference to FIG. 10 to FIG. 14.

First, as shown in FIG. 10, when the end of the adapter 20 and one end of the main pipe 100 are connected by the joint 200, the union of the present invention may be configured to further include a gasket 500 disposed between the end of the adapter 20 and one end of the main pipe 100.

At this time, the gasket 500 may be made of an elastomer including rubber, silicone, and the like, and may be compressed by one end of the main pipe 100 and the end of the adapter 20 approaching each other through the relative movement of the mutually interlocked screw threads as the joint 200 rotates.

Such a compressed gasket 500 may maintain the air tightness between the adapter 20 and a connection point of the main pipe 100. Furthermore, although the thickness is decreased due to the compressing, the width is increased so that the outer circumferential surface is in close contact with the inner circumferential surface of the joint 200, thereby improving the air tightness of the joint 200 itself.

Particularly, the outer circumferential surface of the gasket 500, which is in close contact with the inner circumferential surface of the joint 200 as the gasket 500 is compressed, may fill a gap between the threads formed along the inner circumferential surface of the joint 200, so that it is possible to prevent the fluid from leaking between the male screw of the interlocked adapter 20 and the female screw of the joint 200.

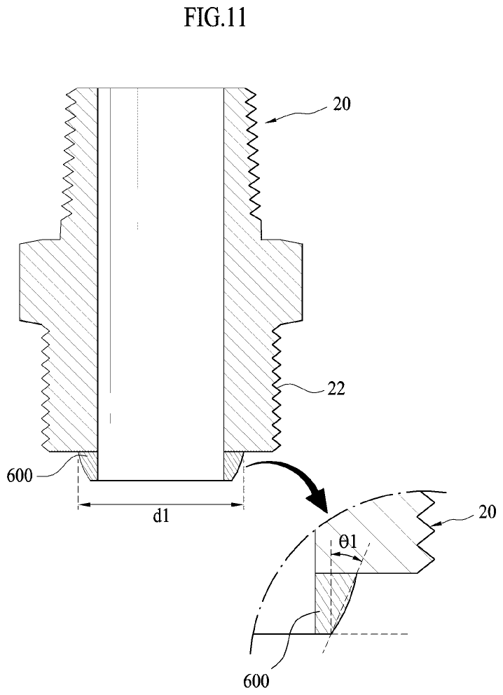

Furthermore, as shown in FIG. 11, the union of the present invention may further include a sealing guide 600 provided at the end of the adapter 20.

The sealing guide 600 may be provided to abut against and be inserted into an inner circumferential surface 520 of a gasket hole 510 which is formed in the center of the gasket 500 so as to allow the fluid to pass through, when the end of the adapter 20 and one end of the main pipe 100 are connected by the joint 200.

The sealing guide 600 may be protruded around the lower end of the adapter 20 contacting one end of the main pipe 100, and may be formed of a ring-shaped protrusion having a protruded neb facing the main pipe 100.

The sealing guide 600 may have the same inner diameter as the inner circumferential surface of the adapter 20 through which the fluid flows, and the neb of the sealing guide 600 may be inserted into the gasket hole 510 to be in contact with one end of the main pipe 100 and in contact with the upper surface of one end of the main pipe 100.

At this time, the sealing guide 600 may be formed in a tapered shape whose outer diameter is gradually reduced toward the neb that is preferentially inserted into the gasket hole 510, and the outer circumferential surface may be a inclined surface having a first inclination angle θ1.

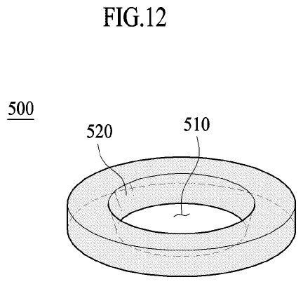

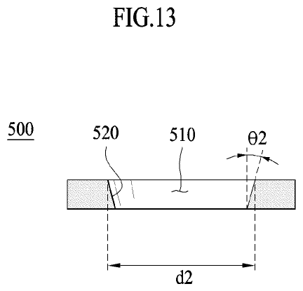

Meanwhile, as shown in FIG. 12 and FIG. 13, the gasket 500 may be provided in such a manner that the diameter of the gasket hole 510 gradually decreases toward the main pipe 100, corresponding to the shape of the above described sealing guide 600, so that the inner circumferential surface 520 may be a inclined surface having a second inclination angle θ2.

The sealing guide 600 may be guided and inserted into the gasket hole 510 more easily through the inclined surfaces having the first inclination angle θ1 and the second inclination angle θ2. As the sealing guide 600 is inserted into the gasket hole 510, the gasket 500 can be stably fixed in its original position without swaying between the adapter 20 and the main pipe 100.

In addition, the outer diameter d1 (see FIG. 11) of the sealing guide 600 may be formed to be larger than the diameter d2 of the gasket hole 510, so that the gasket 500 may be extended in an outward direction when the sealing guide 600 is inserted into the gasket hole 510.

The outer circumferential surface of the outwards extended gasket 500 may be in close contact with the inner circumferential surface of the joint 200 to seal the gap between the screw threads of the joint 200 and the screw threads of the adapter 20.

Further, the first inclination angle θ1 (see FIG. 11) of the outer circumferential surface of the sealing guide 600 may be formed to have an angle larger than the second inclination angle θ2 of the inner circumferential surface of the gasket 500.

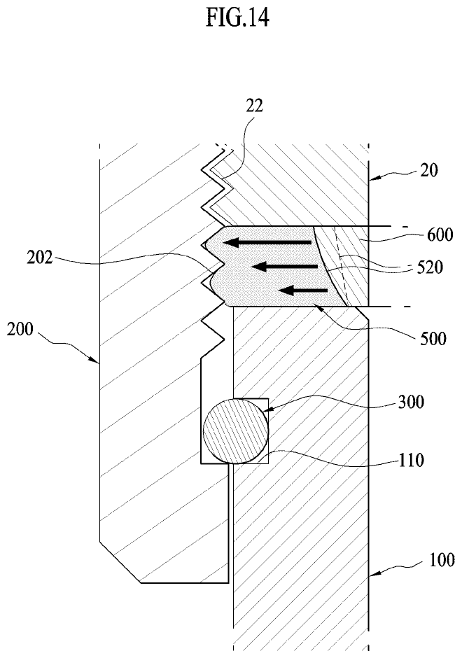

Thus, as shown in FIG. 14, when the sealing guide 600 is inserted into the gasket hole 510, the outer circumferential surface of the gasket 500 adjacent to the adapter 20 side may be further extended in the outward direction, and the air tightness can be more improved by completely sealing the gap between the joint 200 and the screw threads of the adapter 20 with the gasket 500.

Since the union of the present invention can be naturally sealed in a coupling process of connecting the joint 200 to the adapter 20 through the above described additional configuration, it is advantageous in that a sealing means which is difficult to work with, such as a teflon tape, is not required.

It is obvious to those skilled in the art that the present invention can be embodied in other specific forms without departing from the spirit or scope of the invention as defined in the appended claims.

Therefore, the above-described embodiments are to be considered as illustrative and not restrictive, and the invention is not limited to the above description, but may be modified within the scope and equivalence of the appended claims.

1. A union comprising:
a main pipe which has one end that is connected to an adapter installed to introduce or discharge a fluid into equipment to form a pipe conduit;
a joint which is able to be idle and provided at one end of the main pipe, and has a screw thread corresponding to a screw thread formed at an end of the adapter to connect one end of the main pipe to the end of the adapter through the screw thread; and
a stopper which is inserted and fixed in a stopper groove formed at one end of the main pipe to prevent the joint from being detached from the main pipe.

2. The union of claim 1, wherein the stopper is formed of a ring having an outer diameter larger than an outer diameter of the main pipe, and
wherein the joint is inserted into the main pipe through one end of the main pipe, is able to move along a longitudinal direction of the main pipe and to be idle on the main pipe, and has an engagement protrusion, formed at a lower end, having an inner diameter smaller than the outer diameter, wherein a movement of the joint on the main pipe is restricted in any one direction to prevent the joint from being detached from one end of the main pipe.

3. The union of claim 2, wherein the stopper is disposed between an outer circumferential surface of the main pipe and an inner circumferential surface of the joint where the engagement protrusion is formed to prevent the fluid which is introduced or discharged through the adapter from leaking to an external, when the end of the adapter and one end of the main pipe are connected by the joint.

4. The union of claim 2, wherein the stopper comprises an opening portion in which a part of continuous ring shape is broken open, and is shrunk by elastic deformation while being fitted to the outer circumferential surface of the main pipe through the opening portion and fixed to the stopper groove.

5. The union of claim 4, wherein the stopper comprises a stretcher which is formed on an opposite side of the opening portion and has a section where a cross-sectional area is sharply reduced.

6. The union of claim 2, wherein the stopper comprises a stopper packing provided around a ring-shaped outer circumferential surface,
wherein the stopper packing is provided to be in close contact with an inner circumferential surface of the joint where the engagement protrusion is formed, when the end of the adapter and one end of the main pipe are connected by the joint.

7. The union of claim 1, further comprising a gasket which is disposed between the end of the adapter and one end of the main pipe, when the end of the adapter and one end of the main pipe are connected by the joint.

8. The union of claim 7, wherein the gasket is made of an elastomer including rubber, silicone, and the like, and is compressed by one end of the main pipe and the end of the adapter approaching each other through a relative movement of screw threads as the joint rotates.

9. The union of claim 8, wherein a gasket hole is formed in a center of the gasket so as to allow the fluid to pass through, and
wherein the adapter is provided with a sealing guide provided to abut against and be inserted into an inner circumferential surface of the gasket hole, when the end of the adapter and one end of the main pipe are connected by the joint.
